(19) United States
(12) Patent Application Publication
(10) Pub. No.: US 2015/0323034 A1
(43) Pub. Date: Nov. 12, 2015

(54) ENERGY ABSORBER SYSTEM AND VEHICLE

(71) Applicant: GM GLOBAL TECHNOLOGY OPERATIONS LLC, Detroit, MI (US)

(72) Inventors: Scott W. Thorpe, Milford, MI (US); John M. Kuehnel, Sterling Heights, MI (US); Jason M. Miller, St. Clair Shores, MI (US)

(73) Assignee: GM GLOBAL TECHNOLOGY OPERATIONS LLC, Detroit, MI (US)

(21) Appl. No.: 14/272,591

(22) Filed: May 8, 2014

(51) Int. Cl. F16F 7/12

(52) U.S. Cl. CPC F16F 7/12

(57) ABSTRACT

An energy absorber system for a vehicle includes a first panel and a second panel spaced apart from the first panel to define a cavity therebetween, wherein the second panel defines an aperture therethrough. The energy absorber system also includes an energy absorber disposed within the cavity and attached to the first panel. The energy absorber system further includes a plurality of fasteners, and a plate mounted to the second plate by the plurality of fasteners so as to cover the aperture. A vehicle including the energy absorber system is also disclosed.

### TECHNICAL FIELD

The disclosure relates to an energy absorber system and a vehicle.

### BACKGROUND

Vehicles generally include a body and one or more components pivotably attached to the body. For example, components such as a trunk lid, a hood or bonnet, and one or more doors may pivot with respect to the body to provide access to a storage, engine, or passenger compartment of the vehicle. Such components may be formed from two or more individual panels each spaced apart from one another.

### SUMMARY

An energy absorber system for a vehicle includes a first panel and a second panel spaced apart from the first panel to define a cavity therebetween. The second panel defines an aperture therethrough. The energy absorber system also includes an energy absorber disposed within the cavity and attached to the first panel. The energy absorber system further includes a plurality of fasteners, and a plate mounted to the second panel by the plurality of fasteners so as to cover and the aperture.

In one embodiment, the plate has a perimeter and each of the plurality of fasteners is spaced apart from one another along the perimeter. The plate covers the aperture and encloses the energy absorber within the cavity. Further, the first panel is translatable towards the second panel in response to a force. In addition, the energy absorber, the plate, and each of the plurality of fasteners are transitionable between an undeformed state and a deformed state to absorb energy as the first panel translates towards the second panel.

A vehicle includes an energy absorber system. The energy absorber system includes a first panel and a second panel spaced apart from the first panel to define a cavity therebetween. The second panel defines an aperture therethrough. The energy absorber system also includes an energy absorber disposed within the cavity and attached to the first panel. In addition, the energy absorber includes a plurality of fasteners, and a plate mounted to the second panel by the plurality of fasteners so as to cover the aperture. Further, the vehicle includes a member spaced opposite the plate.

The above features and advantages and other features and advantages of the present disclosure will be readily apparent from the following detailed description of the preferred embodiments and best modes for carrying out the present disclosure when taken in connection with the accompanying drawings and appended claims.

### BRIEF DESCRIPTION OF THE DRAWINGS

FIG. 1 is a schematic illustration of a perspective view of a vehicle including an energy absorber system;

FIG. 2 is a schematic illustration of a fragmentary perspective view of the energy absorber system of FIG. 1 including a first panel and a second panel spaced apart from the first panel;

FIG. 3 is a schematic illustration of a fragmentary perspective view of an energy absorber attached to the first panel of FIG. 2;

FIG. 4 is a schematic illustration of a fragmentary perspective view of a plate mounted to the second panel of FIGS. 2 and 3;

FIG. 5A is a schematic illustration of a cross-sectional view of a portion of the vehicle of FIG. 1, taken along section lines 5-5, before a force is applied to the vehicle;

FIG. 5B is a schematic illustration of a cross-sectional view of the portion of the vehicle of FIG. 5A after a force is applied to the vehicle;

FIG. 6 is a schematic illustration of a fragmentary plan view of another embodiment of the plate of FIG. 4;

FIG. 7 is a schematic illustration of a fragmentary plan view of an additional embodiment of the plate of FIG. 4; and

FIG. 8 is a schematic illustration of a fragmentary plan view of a further embodiment of the plate of FIG. 4.

### DETAILED DESCRIPTION

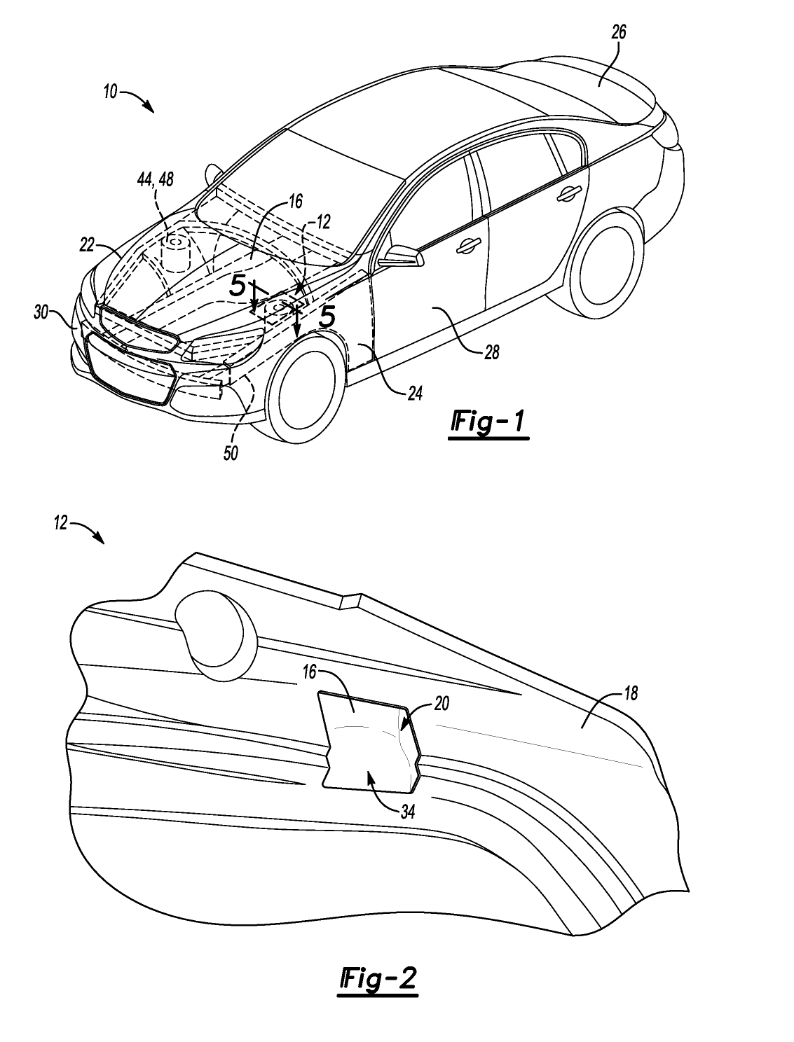

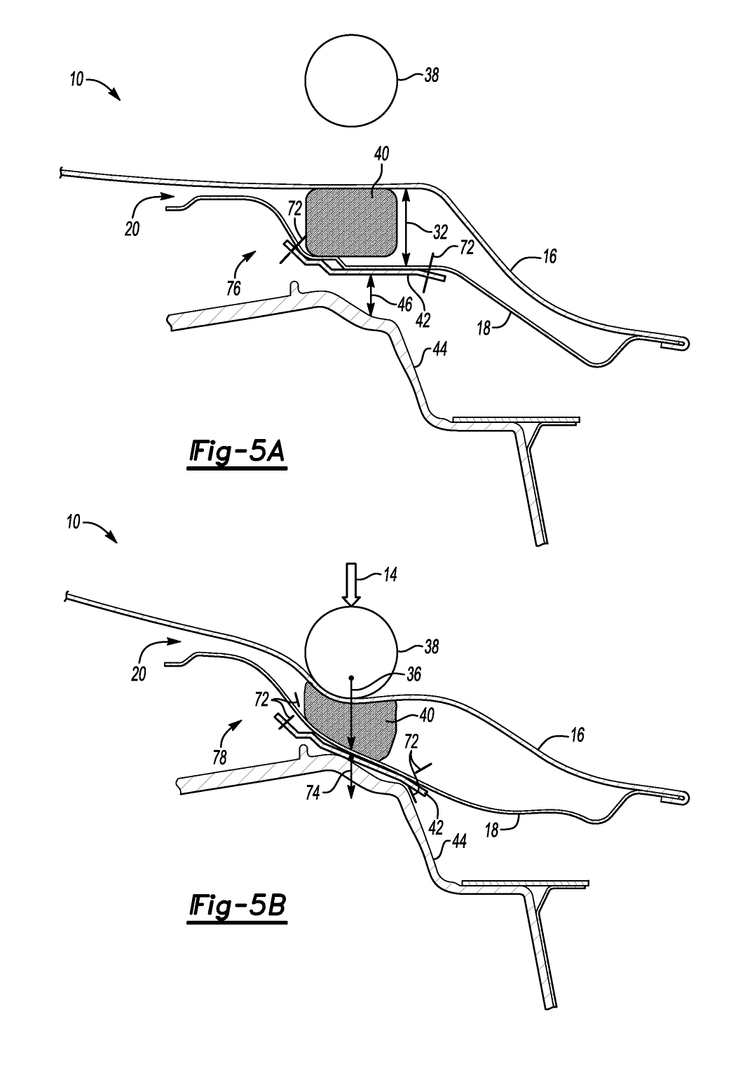

Referring to the Figures, wherein like reference numerals refer to like elements, a vehicle 10 is shown generally in FIG. 1. The vehicle 10 may be, for example, an automobile or a recreational vehicle. The vehicle 10 includes an energy absorber system 12 configured to absorb energy as a force (denoted generally at 14 in FIG. 5B) is applied to the vehicle 10. Therefore, the vehicle 10 may be useful for operating environments requiring energy management and/or dissipation.

Referring now to FIG. 2, the energy absorber system 12 includes a first panel 16 and a second panel 18 spaced apart from the first panel 16 to define a cavity 20 therebetween. The first panel 16 and the second panel 18 may form, for example, a hood or bonnet (shown generally at 22 in FIG. 1) of the vehicle 10. In other non-limiting examples shown in FIG. 1, the first panel 16 and the second panel 18 may form a body 24 of the vehicle 10, a trunk decklid 26 of the vehicle 10, one or more doors 28 of the vehicle 10, or a bumper 30 of the vehicle 10. Generally, the first panel 16 and the second panel 18 may be spaced apart from each other by a first distance 32 (FIG. 5A) of from about 15 mm to about 45 mm, e.g., from about 25 mm to about 35 mm, or about 29 mm, to define the cavity 20 therebetween.

With continued reference to FIG. 2, the second panel 18 defines an aperture 34 therethrough. The aperture 34 may have any size and shape, such as a substantially rectangular shape as shown in FIG. 2. The first panel 16 and the second panel 18 may be formed from the same material, or may be formed from different materials. In one non-limiting example, the first panel 16 and the second panel 18 may be formed from aluminum or an aluminum alloy.

Referring now to FIG. 5B, in one embodiment, the first panel 16 is translatable towards the second panel 18 at a first rate (denoted generally at 36) in response to the force 14. That is, as the force 14 is applied to the first panel 16 from, for example, an object 38 external to the vehicle 10, the first panel 16 may translate or move towards the second panel 18. For example, the first panel 16 may deform or crush in one or more locations and may be pushed towards the second panel 18 by the force 14. As such, the first distance 32 between the first panel 16 and the second panel 18 may decrease as the force 14 is applied to the first panel 16. Although the force 14 is represented generally by an arrow in FIG. 5B, it is to be appreciated that the force 14 may have any magnitude and/or direction. That is, the type and size of the object 38 may vary, and the magnitude and/or direction of the force 14 may also vary accordingly.

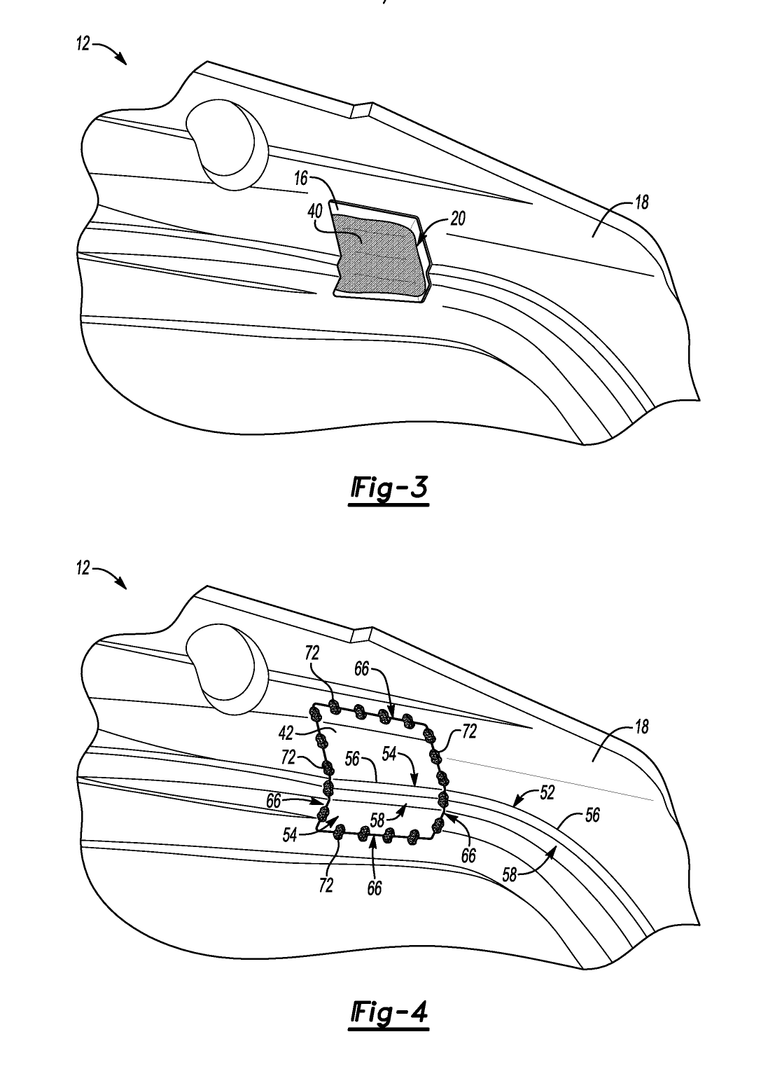

Referring now to FIG. 3, the energy absorber system 12 also includes an energy absorber 40 disposed within the cavity 20 and attached to the first panel 16. As best shown in FIG. 5B, the energy absorber 40 may be deformable, e.g., crushable or tearable, to absorb energy as the first panel 16 translates towards the second panel 18 as the force 14 is applied to the vehicle 10. That is, the energy absorber 40 may be configured to absorb or dissipate energy as the force 14 is applied to the first panel 16. For example, the first panel 16 may translate towards the second panel 18 and deform the energy absorber 40 as the force 14 is applied, and such deformation may dissipate the energy of the applied force 14.

With continued reference to FIG. 3, the energy absorber 40 may be contoured or shaped according to a shape of the first panel 16 and/or the second panel 18. That is, the energy absorber 40 may be suitably shaped and/or sized to fit within the cavity 20. For example, the energy absorber 40 may have any form and may define a plurality of honeycomb-shaped chambers (not shown) and/or corrugated portions (not shown).

As such, the energy absorber 40 may be formed from any material, such as, but not limited to, a foam, a metal, a fiber, a fiber-reinforced composite, and combinations of these materials. In addition, the energy absorber 40 may have a one-piece or unitary construction, or may include multiple components or elements. For example, the energy absorber 40 may be formed from one piece of a single material, such as, without limitation, a single piece of aluminum, steel, magnesium, or alloys thereof, or may be formed from, again without limitation, multiple layers of carbon fiber fabric joined together by a matrix resin.

The energy absorber 40 may also be attached to the first panel 16 in any manner. For example, the energy absorber 40 may be affixed to the first panel 16 by an adhesive (not shown). Alternatively, although not shown, the energy absorber 40 may be welded or bolted to the first panel 16.

Referring now to FIG. 4, the energy absorber system 12 further includes a plate 42 mounted to the second panel 18. More specifically, the plate 42 may cover the aperture 34 (FIG. 2) and enclose the energy absorber 40 (FIG. 3) within the cavity 20 (FIG. 3). Further, the plate 42 may be deformable, e.g., bendable, crushable, tearable, and/or fracturable, to absorb energy as the first panel 16 translates towards the second panel 18.

Referring now to FIGS. 5A and 5B, the vehicle 10 also includes a member 44 spaced opposite the plate 42. The member 44 may face the plate 42 and may be spaced apart from the plate 42 by a second distance 46 (FIG. 5A) of from about 5 mm to about 20 mm, e.g., from about 10 mm to about 15 mm, or about 12 mm. The member 44 may be any comparatively rigid, hard element of the vehicle 10, such as, without limitation, a shock tower (shown generally at 48 in FIG. 1), an internal combustion engine (not shown), a frame member (shown generally at 50 in FIG. 1), a battery (not shown), an electrical component, and the like. The member 44 may be harder than the first panel 16, the second panel 18, and/or the plate 42. That is, the first panel 16 may have a first hardness and the member 44 may have a second hardness that is greater than the first hardness. Therefore, as shown in FIG. 5B and set forth in more detail below, the first panel 16, the second panel 18, and/or the plate 42 may be configured to deform as the plate 42 contacts the member 44.

Referring again to FIG. 4, although the plate 42 may have any shape suitable for covering the aperture 34 (FIG. 2), in one embodiment, the plate 42 may have a rectangular shape. In general, the plate 42 may be sized and/or shaped to match a configuration of the second panel 18. The second panel 18 may have a first contour (indicated generally at 52) and the plate 42 may have a second contour (indicated generally at 54) that is substantially the same shape as the first contour 52. That is, the plate 42 and the second panel 18 may have the same shape. For example, the second panel 18 may include one or more protrusions 56 and/or may define one or more recessions 58. Similarly, the plate 42 may also include the one or more protrusions 56 and/or may define the one or more recessions 58.

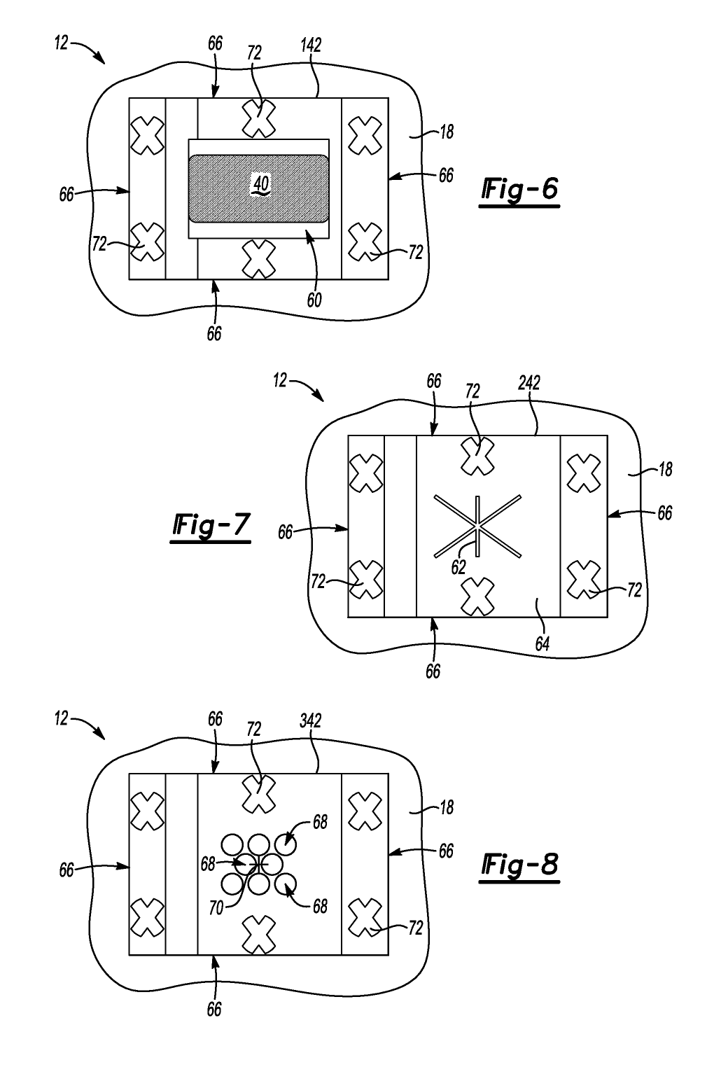

Referring now to FIG. 6, in another embodiment, the plate 142 may define an orifice 60 therethrough having a substantially rectangular shape. For example, the orifice 60 may be concentric with the aperture 34 (FIG. 2). That is, although the plate 142 may be mounted to the second panel 18 so as to cover the aperture 34 and enclose the energy absorber 40 (FIG. 3) within the cavity 20 (FIG. 3), a central portion of the plate 142 may be removed to define the orifice 60. The orifice 60 may contribute to a deformability of the plate 142 and may allow the plate 142 to fold or tear as the plate 142 contacts the member 44 (FIG. 5B) upon application of the force 14 (FIG. 5B) to the first panel 16 (FIG. 5B). As such, the plate 142 may be useful for applications requiring comparatively lightweight vehicles 10 (FIG. 1).

Referring now to FIG. 7, in an additional embodiment, the plate 242 may define at least one slit 62 therein. The at least one slit 62 may extend through the plate 242. Alternatively, the at least one slit 62 may not extend through the plate 242, but may instead define a furrow or groove in an external surface 64 of the plate 242. Therefore, the at least one slit 62 may encourage deformation, e.g., crushing and/or tearing, at a predetermined location corresponding to the at least one slit 62 as the force 14 (FIG. 5B) is applied to the first panel 16 (FIG. 5B). Such deformation may therefore also dissipate energy from the force 14.

Referring now to FIG. 8, in a further embodiment, the plate 342 may have a perimeter 66 and may define a plurality of holes 68 therethrough each spaced apart from the perimeter 66. That is, the plurality of holes 68 may each be spaced apart from the perimeter 66 so as to be concentrated near a center 70 of the plate 342. The plurality of holes 68 may also encourage deformation, e.g., crushing, bending, folding, and/or tearing, at a predetermined location corresponding to the plurality of holes 68 as the force 14 (FIG. 5B) is applied to the first panel 16 (FIG. 5B). Further, the plurality of holes 68 may contribute to a decreased weight of the plate 342, which may be advantageous for applications requiring comparatively lightweight vehicles 10.

Referring again to FIGS. 4 and 6-8, the energy absorber system 12 also includes a plurality of fasteners 72. More specifically, the plate 42, 142, 242, 342 is mounted to the second panel 18 by the plurality of fasteners 72 so as to cover the aperture 34 (FIG. 2). Further, each of the plurality of fasteners 72 may also be deformable to absorb energy as the first panel 16 (FIG. 4) translates towards the second panel 18 (FIG. 4) as the force 14 (FIG. 5B) is applied to the vehicle 10. For example, the plurality of fasteners 72 may break away, tear, shear, crush, crumble, pop, crimp, fold, and/or fatigue as the first panel 16 translates towards the second panel 18 upon application of the force 14. Therefore, the plurality of fasteners 72 may also dissipate, absorb, and/or manage energy as the plate 42, 142, 242, 342 translates towards the member 44 (FIG. 5B).

The energy absorber system 12 may include any number of fasteners 72. For example, the energy absorber system 12 may include from four fasteners 72 to twenty fasteners 72, or from six fasteners 72 to sixteen fasteners 72. Further, the plurality of fasteners 72 may be arranged in any configuration and/or disposed in any location along the plate 42, 142, 242, 342 and the second panel 18. For example, referring again to FIG. 4, each of the plurality of fasteners 72 may be spaced apart from one another along the perimeter 66 of the plate 42. Alternatively or additionally, as best shown in FIGS. 6-8, the plurality of fasteners 72 may be equally spaced apart from one another along the plate 142, 242, 342.

By way of non-limiting examples, the plurality of fasteners 72 may include a weld, a rivet, an adhesive, a snap, a crimp, a bolt, a screw, a hook-and-loop device, and combinations thereof. Further, each of the plurality of fasteners 72 may be the same as every other one of the plurality of fasteners 72, or one or more of the plurality of fasteners 72 may be different from another.

Therefore, in operation as described with reference to FIGS. 5A and 5B, upon application of the force 14 (FIG. 5B) to the first panel 16, the first panel 16 may translate towards the second panel 18 at the first rate 36 (FIG. 5B) in response to the force 14. That is, the force 14 may deform the first panel 16 and decrease the first distance 32 (FIG. 5A) between the first panel 16 and the second panel 18. Concurrently, the energy absorber 40 may also deform, e.g., crush, tear, fold, and/or fatigue, upon contact from the first panel 16. Therefore, the energy absorber 40 may absorb, redirect, dissipate, and/or manage energy transferred from the first panel 16 as the first panel 16 deforms in response to the force 14.

Accordingly, with continued reference to FIG. 5B, as the energy absorber 40 and/or the first panel 16 translate towards the second panel 18, the second panel 18 and/or the plate 42, 142, 242, 342 may translate towards the member 44. However, since the energy absorber 40 absorbs a portion of the energy from the force 14, the second panel 18 is translatable towards the member 44 in response to the force 14 at a second rate (indicated generally by 74) that is less than the first rate 36. That is, the energy absorber 40 may slow translation of the second panel 18 towards the member 44.

In addition, referring again to FIG. 5B, as the second panel 18 translates towards and/or abuts the member 44, the plate 42, 142, 242, 342 and/or the plurality of fasteners 72 may also deform, e.g., tear, crush, and/or fold, to further absorb the energy from the force 14 and further slow or minimize translation of the second panel 18. That is, the energy absorber 40, the plate 42, 142, 242, 342, and each of the plurality of fasteners 72 may be transitionable between an undeformed state 76 (FIG. 5A) and a deformed state 78 to absorb energy as the first panel 16 translates towards the second panel 18. More specifically, the undeformed state 76 may represent a shape or state of the energy absorber 40, the plate 42, 142, 242, 342, and/or the plurality of fasteners 72 before the force 14 is applied to the first plate 16. Conversely, the deformed state 78 may represent a shape or state of the energy absorber 40, the plate 42, 142, 242, 342, and/or the plurality of fasteners 72 after the force 14 is applied to the first plate 16. For example, the deformed state 78 of the plurality of fasteners 72 may represent a shorn, cracked, torn, crumbled, fatigued, fractured, and/or bent state or form of the plurality of fasteners 72.

As such, as the energy absorber 40, the plate 42, 142, 242, 342, and the plurality of fasteners 72 transition from the undeformed state 76 (FIG. 5A) to the deformed state 78 (FIG. 5B), the energy absorber 40, the plate 42, 142, 242, 342, and the plurality of fasteners 72, alone or in combination, may minimize energy absorption by the object 38, and may instead encourage energy absorption by the energy absorber system 12 and the vehicle 10. That is, the energy absorber system 12 may absorb and dissipate energy so that the object 38 rolls or deflects away from the first panel 16 after the object 38 contacts the first panel 16. Further, the energy absorber system 12 may allow the first panel 16 to be formed from a comparatively lighter and/or softer material, e.g., aluminum, without requiring an increased spacing between the first panel 16 and the second panel 18 to mitigate energy from the force 14. That is, the energy absorber system 12 may allow the first panel 16 to deform upon contact with the object 38 and prevent the first panel 16 from contacting the member 44 even when the first panel 16 is spaced apart from the second panel 18 by the first distance 32 (FIG. 5A).

While the best modes for carrying out the disclosure have been described in detail, those familiar with the art to which this disclosure relates will recognize various alternative designs and embodiments for practicing the disclosure within the scope of the appended claims.

1. An energy absorber system for a vehicle, the energy absorber system comprising:
a first panel;
a second panel spaced apart from the first panel to define a cavity therebetween, wherein the second panel defines an aperture therethrough;
an energy absorber disposed within the cavity and attached to the first panel;
a plurality of fasteners; and
a plate mounted to the second panel by the plurality of fasteners so as to cover the aperture.

2. The energy absorber system of claim 1, wherein the plate defines an orifice therethrough having a substantially rectangular shape.

3. The energy absorber system of claim 2, wherein the orifice is concentric with the aperture.

4. The energy absorber system of claim 1, wherein the plate defines at least one slit therein.

5. The energy absorber system of claim 4, wherein the at least one slit extends through the plate.

6. The energy absorber system of claim 1, wherein the plate has a perimeter and defines a plurality of holes therethrough each spaced apart from the perimeter.

7. The energy absorber system of claim 1, wherein the plate has a perimeter, and further wherein each of the plurality of fasteners is spaced apart from one another along the perimeter.

8. The energy absorber system of claim 1, wherein each of the plurality of fasteners is equally spaced apart from one another.

9. The energy absorber system of claim 1, wherein the second panel has a first contour and the plate has a second contour that is substantially the same shape as the first contour.

10. An energy absorber system for a vehicle, the energy absorber system comprising:
a first panel;
a second panel spaced apart from the first panel to define a cavity therebetween, wherein the second panel defines an aperture therethrough, and wherein the first panel is translatable towards the second panel in response to a force;
an energy absorber disposed within the cavity and attached to the first panel;
a plurality of fasteners; and
a plate mounted to the second panel by the plurality of fasteners so as to cover the aperture and enclose the energy absorber within the cavity, wherein the plate has a perimeter and each of the plurality of fasteners is spaced apart from one another along the perimeter;
wherein the energy absorber, the plate, and each of the plurality of fasteners are transitionable between an undeformed state and a deformed state to absorb energy as the first panel translates towards the second panel.

11. A vehicle comprising:
an energy absorber system including:
a first panel;
a second panel spaced apart from the first panel to define a cavity therebetween, wherein the second panel defines an aperture therethrough;
an energy absorber disposed within the cavity and attached to the first panel;
a plurality of fasteners; and
a plate mounted to the second panel by the plurality of fasteners so as to cover the aperture; and
a member spaced opposite the plate.

12. The vehicle of claim 11, wherein the first panel is translatable towards the second panel at a first rate in response to a force, and wherein the second panel is translatable towards the member in response to the force at a second rate that is less than the first rate.

13. The vehicle of claim 11, wherein the first panel has a first hardness and the member has a second hardness that is greater than the first hardness.

14. The vehicle of claim 11, wherein the plate defines an orifice therethrough having a substantially rectangular shape.

15. The vehicle of claim 14, wherein the orifice is concentric with the aperture.

16. The vehicle of claim 11, wherein the plate defines at least one slit therein.

17. The vehicle of claim 16, wherein the at least one slit extends through the plate.

18. The vehicle of claim 11, wherein the plate has a perimeter and defines a plurality of holes therethrough each spaced apart from the perimeter.

19. The vehicle of claim 11, wherein the plate has a perimeter, and further wherein each of the plurality of fasteners is spaced apart from one another along the perimeter.
